(19) United States
(12) Patent Application Publication
(10) Pub. No.: US 2026/0153404 A1
(43) Pub. Date: Jun. 4, 2026

(54) Validation method of aerodynamic measurements and associated validation device

(71) Applicant: THALES, Meudon (FR)

(72) Inventors: Roland BONEL, VALENCE (FR); Jean-Philippe PINEAU, VENDOME CEDEX (FR)

(21) Appl. No.: 19/403,779

(22) Filed: Nov. 29, 2025

(30) Foreign Application Priority Data
Nov. 29, 2024 (FR) 2413213

(51) Int. Cl. G01M 9/06; B64D 43/02

(52) U.S. Cl. CPC G01M 9/06; B64D 43/02

(57) ABSTRACT

A method for validating aerodynamic measurements implemented by an architecture including N separate measurement paths each including Pm probes, including: acquisition of an elementary measurement from each probe; for each measurement path, determination of a resultant measurement from the probes belonging to this path, and comparison of the resultant measurements. When the resultant measurements are consistent, validation of the measurements. When a resultant measurement related to path k is inconsistent: selection of a measurement path i, determination of Pi+Pk consistence values, determination of an inconsistent value among all the consistence values, and invalidation of any elementary measurement from the probe corresponding to the inconsistent value.

### REFERENCE TO RELATED APPLICATIONS

This application is a U.S. non-provisional application claiming the benefit of French Patent Application No. 24 13213 filed on Nov. 29, 2024, the contents of which are incorporated herein by reference in their entirety.

### TECHNICAL FIELD OF THE INVENTION

This invention relates to a method for validating aerodynamic measurements.

This invention also relates to a validation device implementing such a method.

The field of the invention is that of critical systems known as “Air Data,” and notably the supervision and safety of such systems.

### BACKGROUND OF THE INVENTION

For many years, the architectures of critical Air Data systems have allowed for the calculation of static pressures and associated secondary parameters by averaging pressures captured by passive probes located on each side (right/left) of aircraft. This average allows for the direct consideration of slip effects and has historically been done pneumatically using tubes connected to a single measurement electronics contained in a computer often called an Air Data Unit (ADU) containing a single pressure sensor and associated electronics.

More recently, digital probes have the advantage of reducing (or even eliminating) the tubes but have the disadvantage of increasing the number of sensors and associated electronics (referred to as “Air Data Electronic Measurement,” ADEM) necessary for calculating a right/left static pressure average.

In particular, digital probes generally require at least two ADEM to perform an average calculation where in older architectures, a single ADU was sufficient.

Indeed, in older architectures with passive probes (without measurement electronics in the probe), the sensor, allowing for the calculation of static pressure, measures, in fact, the pneumatic right/left average collected by the two passive probes, which physically corresponds to averaging the pressures on both sides of the aircraft and thus taking into account the disruptive effects of slip. Thus, one ADU per measurement path was sufficient.

In digital architectures, the probes locally include the necessary electronics for calculating static pressure, and as such, they measure the right and left pressures independently, and therefore each must include a sensor and associated electronics (ADEM), which at a minimum doubles the number of ADEM compared to previous systems with “passive” probes. This requires the average of the pressure measurements on one side and the other of the aircraft to be calculated. Thus, at least two ADEM per measurement path are necessary. For example, in such a case, given that it is a critical system, at least three measurement paths each including at least two ADEM are necessary. This brings the total number of ADEM required to 6.

It is then understood that the use of digital probes leads to an increase in their number compared to the pneumatic solution. This therefore reduces the advantages of digital probes.

### SUMMARY OF THE INVENTION

The present invention aims to remedy this disadvantage of digital probes. In particular, the present invention aims to propose a solution that makes it possible to use digital probes while reducing the necessary number of them for operation with a critical system.

To this end, the invention aims at a method for validating aerodynamic measurements implemented by a measurement architecture embedded at least partially in an aircraft and including N separate measurement paths, each measurement path including Pm probes, the index m varying from 1 to N, the method including the following operations:
acquisition of an elementary measurement from each probe;
for each measurement path, determination of a resultant measurement from the elementary measurements of the probes belonging to this measurement path; and
comparison of the resultant measurements among themselves:
   when the resultant measurements are consistent with each other, validation of all the elementary measurements; and
   when a resultant measurement related to path k is inconsistent with the other resultant measurements:
selection of a measurement path i whose number of probes Pi is at least 2;
determination of Pi+Pk consistence values, each consistence value being determined by a consistence function on a subset of elementary measurements of the probes of paths i and k excluding the elementary measurement related to one of the probes belonging to one of the paths;
determination of an inconsistent value among all the consistence values, the inconsistent value being calculated on the subset of elementary measurements excluding the elementary measurement related to probe j; and
invalidation of any elementary measurement from probe j.

According to other advantageous aspects of the invention, the method includes one or more of the following features, taken in isolation or in any technically possible combination:
the method further includes an operation of analyzing the consistence of the elementary measurements among themselves, from the probes of path k when the number of probes Pk in this path k is strictly greater than 2;
the consistence function is defined beforehand based on at least one parameter chosen from the group including:
   speed of the aircraft;
   shape of the aircraft;
   aerodynamic configuration of the aircraft;
   placement of the corresponding probes; and
   nature of the corresponding probes.
the probes of the same measurement path are arranged on different sides of the aircraft;
each measurement path m includes Pm/2 probes arranged on one side of the aircraft and Pm/2 probes arranged on the other side of the aircraft;
each probe is a static pressure probe;
the consistence function is defined based on the SSEC (“Static Source Error Correction”) laws of the corresponding probes;
all the probes are of the same nature; and
N=2 and Pm=2 for all index m.

The invention also relates to a computer program including software instructions which, when executed by a computer, implement the method as defined above.

The invention also aims at a validation device including technical means configured to implement the method as defined below.

### BRIEF DESCRIPTION OF THE DRAWINGS

The invention will appear more clearly upon reading the following description, given solely by way of non-limiting example, and made with reference to the drawings wherein:

FIG. 1 is a schematic view of an aeronautical measurement architecture, the architecture including a validation device according to the invention;

FIG. 2 is a detailed schematic view of the validation device shown in FIG. 1; and

FIG. 3 is a flowchart of a validation method according to the invention, the method being implemented by the validation device shown in FIG. 2.

### DETAILED DESCRIPTION OF THE INVENTION

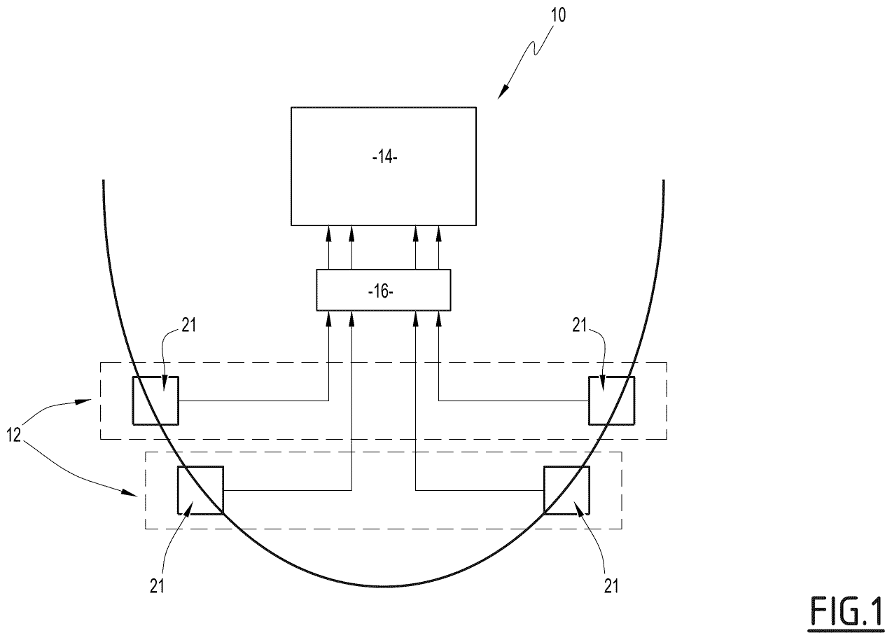

FIG. 1 illustrates an aeronautical measurement architecture 10. This architecture 10 is advantageously embedded at least partially in an aircraft.

The term “aircraft” means any pilotable or remotely piloted or autonomous device that is capable of moving through the air. In particular, an aircraft may correspond to an airplane or a helicopter or a drone. The aircraft may be piloted by a pilot from a cockpit of the same and/or by any other operator from a remote control center.

Referring to FIG. 1, the aeronautical measurement architecture 10 includes N measurement paths 12, a processing system 14, and a validation device 16.

The measurement paths 12 are independent of each other and allow for aerodynamic measurements, such as static pressure, to be provided independently.

In particular, each measurement path 12 includes Pm probes 21, the index m varying from 1 to N. Each number Pm is greater than or equal to 1.

Each probe 21 is a digital probe allowing for an aerodynamic measurement, such as static pressure, to be provided in the form of a numerical value. To do this, each probe 21 is advantageously arranged outside the aircraft. Each probe 21 is, for example, fixed on the fuselage of the aircraft.

The probes 21 of the same measurement path 12 are advantageously arranged on different sides of the aircraft. For example, Pm/2 probes 21 of each measurement path 12 are arranged on the right side of the aircraft and the other Pm/2 probes 21 of this same measurement path 12 are arranged on the left side.

Moreover, advantageously, the probes 21 within the same measurement path 12 are all of the same nature. In other words, these probes 21 allow for the same physical quantity to be measured. It is further considered hereafter, without loss of generality, that the probes 21 belonging to different paths also allow for the same physical quantity to be measured.

In the example shown in FIG. 1, two measurement paths 12 each including two probes 21 are represented. In other words, in such a case, the number N is equal to 2 and each number Pm (m=1 or 2) is equal to 2. Moreover, the probes 21 of each measurement path 12 are arranged on different sides of the aircraft, namely on the right side and the left side. Thus, in the example shown in FIG. 1, each measurement path 12 includes a left probe and a right probe.

According to another example, the architecture 10 includes N measurement paths 12 and the different measurement paths include a different number of probes. For example, in such a case, P1=2, P2=3, P3=1, . . . , PN=4.

The probes 21 are connected to the processing device 14 and are configured to provide the corresponding aerodynamic measurements to this device 14.

The processing device 14 allows for all the aerodynamic measurements generated by the measurement paths 12 to be received and processed appropriately, in order to provide a result of such processing to any interested system. Such an interested system may, for example, include a human/machine communication interface, a control system (for example, an autopilot), a flight planning system (for example, of the FMS (“Flight Management System”) type), etc. Moreover, the processing device 14 allows for each received aerodynamic measurement to be processed, in accordance with the measurement path that generated this measurement.

In particular, the processing device 14 may include a separate computer for each measurement path 12 to implement independent processing of the aerodynamic measurements from the independent measurement paths 12. The processing device 14 may notably include a computer of the “Air Data Computer” type known in itself.

The validation device 16 according to the invention allows for each aerodynamic measurement from each probe 21 to be validated/invalidated. This validation device 16 is, for example, connected between each probe 21 and the processing device 14.

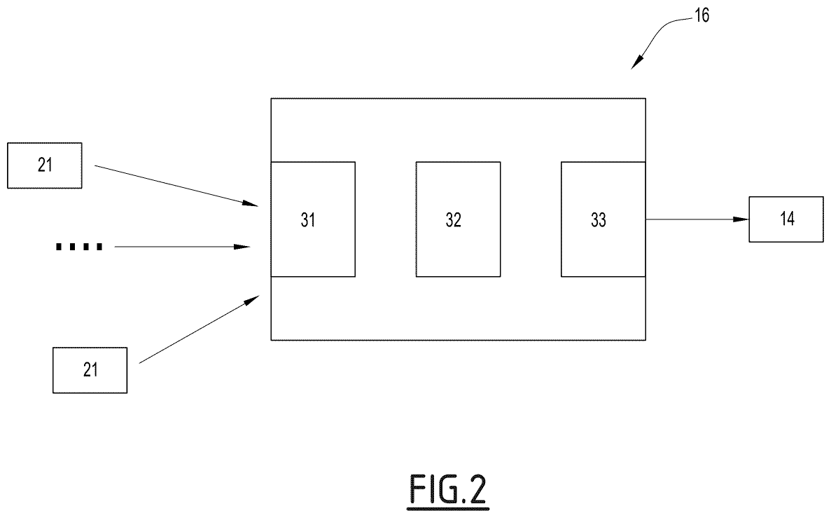

The validation device 14 is illustrated in more detail in FIG. 2.

Referring to this FIG. 2, the validation device 14 notably includes an input module 31, a processing module 32, and an output module 33.

The input module 31 is connected to all the probes 21 and allows for each aerodynamic measurement from each probe 21 to be received.

The processing module 32 allows for processing of all the aerodynamic measurements to validate or invalidate each of them, as will be explained in more detail later.

Moreover, the processing module 32 allows for each validated aerodynamic measurement to be transmitted to the output module 33.

The output module 33 allows for each aerodynamic measurement validated by the processing module 32 to be transmitted to any interested external system and notably to the processing device 14 as explained previously.

Each of these modules 31 to 33 is realized, for example, at least partially in the form of software.

In such a case, the validation device 14 further includes a memory for storing such software as well as a processor for executing this software.

Alternatively or in addition, at least one of these modules 31 to 33 presents at least partially a programmable logic circuit, such as an FPGA (“Field-Programmable Gate Array”).

Other embodiments of the validation device 16 are also possible. Thus, for example, this validation device 16 may include a processing chain for each measurement path allowing for the aerodynamic measurements from this measurement path to be processed separately and a shared area allowing for aerodynamic measurements from different measurement paths to be analyzed and compared.

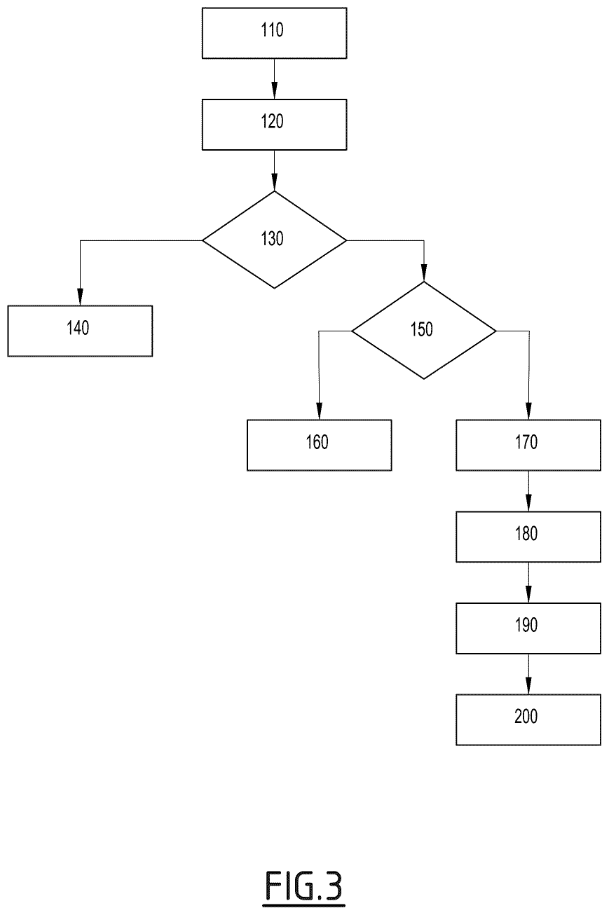

The validation device 16 allows for implementation of a method for validating aerodynamic measurements, which will now be explained with reference to FIG. 3 presenting a flowchart of its steps.

Initially, it is considered that each probe 21 generates an aerodynamic measurement and transmits it to the validation device 16. Such a measurement will hereafter be called an elementary measurement.

During an initial operation 110 of the method, the input module 31 acquires each elementary measurement and transmits it to the processing module 32. Thus, for each measurement path, Pm elementary measurements are transmitted to the processing module 32.

In the example shown in FIG. 1, four elementary measurements namely Ps1_l, Ps1_r, Ps2_l, and Ps2_r corresponding to the measurements generated respectively by the left probe of the first path, the right probe of the first path, the left probe of the second path, and the right probe of the second path are then generated.

During a subsequent operation 120, for each measurement path 12, the processing module 32 determines a resultant measurement from all the elementary measurements from the probes 21 belonging to this measurement path 12.

The resultant measurement for each measurement path is calculated, for example, using the same function F on all the elementary measurements corresponding to this path. This function F may correspond, for example, to an average or any other function known in itself for calculating a resultant value from a plurality of samples.

In other words, during this operation, N resultant measurements are calculated.

In the example shown in FIG. 1, during this operation 120, two resultant measurements, namely the measurements Ps1 and Ps2 corresponding respectively to the averages of the values Ps1_l and Ps1_r, and Ps2_l and Ps2_r are determined.

During a subsequent operation 130, the processing module 32 compares all the resultant measurements among themselves to determine their consistence. For this, a specific function, known in itself, may be used. For example, two resultant measurements may be considered consistent when the difference between these measurements is less than a predetermined threshold. Otherwise, these measurements are inconsistent.

The consistence analysis may be performed, for example, by comparing the measurements two by two.

Thus, when N>2, the processing module 32 may determine an inconsistent resultant measurement when it is inconsistent with each other resultant measurement given that these other resultant measurements are consistent with each other.

When N=2, the processing module 32 concludes that when the two resultant measurements are sufficiently different, each of these resultant measurements is inconsistent.

In the example shown in FIG. 1, the measurements Ps1 and Ps2 may be consistent when their difference is less than a threshold.

When following the implementation of the consistence analysis, the processing module 32 concludes that all the resultant measurements are consistent with each other, during the subsequent operation 140, it validates all the elementary measurements (or resultant measurements) and transmits them to the output module 33. This output module 33 in turn transmits these measurements to the processing device 14.

When, on the contrary, the processing module 32 determines an inconsistent resultant measurement compared to the others, it proceeds to execute operation 150 and the following operations in relation to this measurement. It is then considered that the inconsistent measurement comes from the measurement path having the index k.

During the subsequent operation 150, the processing module 32 first attempts to analyze the consistence of the elementary measurements among themselves within the measurement path k.

When this is possible (notably when Pk>2), the processing module 32 determines the probe having the index j which provides the elementary measurement causing the inconsistence and excludes from any consideration any elementary measurement from probe j. Then, during the subsequent operation 160, the processing module 32 validates all the elementary measurements except for the one from probe j and transmits them to the output module 33. This output module 33 in turn transmits these measurements to the processing device 14.

When this is not possible (notably when Pk≤2), the processing module 32 proceeds to execute a subsequent operation 170.

During operation 170, the processing module 32 selects a measurement path i, different from measurement path k, whose number of probes Pi is at least 2.

During a subsequent operation 180, the processing module 32 determines Pi+Pk consistence values.

Each consistence value corresponds to the value of a consistence function calculated on a subset of elementary measurements of paths i and k excluding the elementary measurement related to one of the probes belonging to one of the paths. Thus, each consistence value is determined from Pi+Pk−1 elementary measurements and is associated with the probe 21 whose elementary measurement was excluded for its calculation.

According to a particular embodiment, the consistence function is defined beforehand based on at least one parameter chosen from the group including:
speed of the aircraft;
shape of the aircraft;
aerodynamic configuration of the aircraft;
placement of the corresponding probes; and
nature of the corresponding probes.

For example, the consistence function may be defined based on the SSEC (“Static Source Error Correction”) laws of the corresponding probes. These SSEC laws may be defined during dedicated flight tests.

In the example shown in FIG. 1, a consistence value is determined for each subset of three elementary measurements.

In other words, the following consistence values are determined:
F³(Ps1_l, Ps1_r, Ps2_l)=Ps1_3_inf
F³(Ps1_l, Ps1_r, Ps2_r)=Ps2_3_inf
F³(Ps2_l, Ps2_r, Ps1_l)=Ps3_3_inf
F³(Ps2_l, Ps2_r, Ps1_r)=Ps4_3_inf
where F³( . . . ) is the applicable consistence function in this example.

During a subsequent operation 190, the processing module 32 determines among all the consistence values an inconsistent value with the other consistence values. In other words, it is an inconsistent value compared to the Pi+Pk−2 other values.

In particular, to determine such an inconsistent value, the processing module 32 analyzes all the consistence values and chooses among these values the one that differs the most from the others. Various techniques known in themselves may be used for this purpose. For example, the inconsistent value may be closer to the resultant measurement provided by one of the measurement paths other than measurement path k than the other consistence values. In this context, the inconsistent value may correspond to a non-erroneous measured value while all the other consistence values may correspond to an erroneous measurement.

Then, the processing module 32 determines the probe j corresponding to this inconsistent value. In other words, the processing module 32 determines the probe j whose elementary measurement was excluded from the calculation of the inconsistent value.

In the example shown in FIG. 1, the consistence value Ps1_3_inf may be closer to the value Ps1 than the other consistence values Ps2_3_inf, Ps3_3_inf, and Ps4_3_inf. As a result, the consistence value Ps1_3_inf may correspond to a non-erroneous measurement while the other consistence values Ps2_3_inf, Ps3_3_inf, and Ps4_3_inf may correspond to an erroneous measurement. In such a case, during this step 190, the value Ps1_3_inf is considered the inconsistent value.

During the subsequent operation 200, the processing module 32 validates all the elementary measurements except for the one from probe j and transmits them to the output module 33. This output module 33 in turn transmits these measurements to the processing device 14.

According to one embodiment, the processing module 32 may apply even more techniques to validate/invalidate an elementary measurement. These techniques may be applicable when, for example, two probes are found to be faulty. These techniques may include the use of yaw information (or even other information from the Fly-by-Wire Controls—FBW FCS) combined with consistence control. This operation is facilitated if the Air Data function is hosted in a partition of the FBW FCS or IRS (Inertial Reference System) computer.

It is then understood that the present invention presents a number of advantages. In particular, it is clear that the invention allows for the number of measurement paths necessary to operate with a critical system to be reduced. In particular, two measurement paths each including two probes may be sufficient to operate with a critical system. Of course, it remains possible to increase the number of measurement paths and/or probes to further increase the reliability/availability of the architecture.

1. A method for validating aerodynamic measurements implemented by an aeronautical measurement architecture embedded at least partially in an aircraft and comprising N separate measurement paths, each measurement path comprising Pm probes, the index m varying from 1 to N, the method comprising:
acquiring an elementary measurement from each probe;
for each measurement path, determining a resultant measurement from the elementary measurements of the probes belonging to this measurement path; and
comparing the resultant measurements among themselves:
when the resultant measurements are consistent with each other, validating the elementary measurements; and
when a resultant measurement related to path k is inconsistent with the other resultant measurements:
selecting a measurement path i whose number of probes Pi is at least 2;
determining Pi+Pk consistence values, each consistence value being determined by a consistence function on a subset of elementary measurements of the probes of paths i and k excluding the elementary measurement related to one of the probes belonging to one of the paths;
determining an inconsistent value among all the consistence values, the inconsistent value being calculated on the subset of elementary measurements excluding the elementary measurement related to probe j; and
invalidating any elementary measurement from probe j.

2. The method according to claim 1, further comprising analyzing consistence of the elementary measurements among themselves, from the probes of path k when the number of probes Pk in this path k is strictly greater than 2.

3. The method according to claim 1, wherein the consistence function is defined beforehand based on at least one parameter chosen from the group consisting of speed of the aircraft, shape of the aircraft, aerodynamic configuration of the aircraft, placement of the corresponding probes, and nature of the corresponding probes.

4. The method according to claim 1, wherein the probes of the same measurement path are arranged on different sides of the aircraft.

5. The method according to claim 4, wherein each measurement path m comprises Pm/2 probes arranged on one side of the aircraft and Pm/2 probes arranged on the other side of the aircraft.

6. The method according to claim 1, wherein each probe comprises a static pressure probe.

7. The method according to claim 6, wherein the consistence function is defined based on the SSEC (Static Source Error Correction) laws of the corresponding probes.

8. The method according to claim 1, wherein the probes are all of the same nature.

9. The method according to claim 1, wherein N=2 and Pm=2 for all index m.

10. A validation device of aerodynamic measurements comprising:
an input module;
a processing module; and
an output module configured to implement the method according to claim 1.
